(19) United States
(12) Patent Application Publication
(10) Pub. No.: US 2008/0166081 A1
(43) Pub. Date: Jul. 10, 2008

(54) SYSTEM AND METHOD FOR RETAINING ROLLERS OF A FULL COMPLEMENT NEEDLE BEARING

(75) Inventors: David E. Crittenden, Schaumburg, IL (US); Janusz Figiel, Mundelein, IL (US)

Correspondence Address: Levenfeld Pearlstein, LLC (ILLINOIS TOOL WORKS), 2 North LaSalle Street, Suite 1300, Chicago, IL, 60602, US

(73) Assignee: ILLINOIS TOOL WORKS, INC., Glenview, IL (US)

(21) Appl. No.: 11/621,659

(22) Filed: Jan. 10, 2007

(51) Int. Cl. F16C 19/22; B21D 53/10

(52) U.S. Cl. 384/548; 29/898.061

(57) ABSTRACT

A full complement needle bearing includes a race and a plurality of rollers. The race defines an opening for receiving an associated shaft. The race has first and second radially inwardly directed collars on opposing ends of the race to form a channel. The first collar includes a first groove formed along an inner surface of the first collar, and the second collar includes a second groove formed along an inner surface of the second collars. Each of the plurality of rollers has a central portion, a first nib extending from one end of the central portion and a second nib extending from an opposing end of the central portion. At least a portion of the first nib is retained within the first groove and at least a portion of the second nib is retained within the second groove so as to retain the rollers parallel to the associated shaft.

### BACKGROUND OF THE INVENTION

The present invention is directed to a bearing. More particularly, the present invention is directed to a system and method for retaining in place the rollers of a full complement needle bearing.

Needle bearings are one of the well-known types of bearings used to provide low-friction movement between two surfaces. Needle bearings include an outer bearing ring that permits a set of rollers to roll between an inner surface of the outer bearing ring and a shaft inserted into the bearing. Generally, the rollers used in needle bearings have high length-to-diameter ratios (hence the name the needle bearing) as compared to typical roller bearings.

One type of needle bearing is a full complement need bearing. Full complement needle bearings typically include a full complement of rollers packed against each other around an entire periphery to define the bearing surface, but do not include any inner ring or cage to retain the rollers. This design provides the highest load-to-size ratio for a given roller diameter and length, thus minimizing the amount of space required for the bearing.

However, there are drawbacks to the typical full complement needle bearing design. Most notably, whenever the shaft is removed to perform maintenance or to lubricate the bearing, the rollers tend to fall out of the outer bearing ring. The rollers are then difficult and tedious to replace.

Accordingly, there is a need for an improved full-complement needle bearing in which the rollers are maintained in place with the shaft removed. Desirably, such a bearing is compact and provides a high load-to-size ratio.

### BRIEF SUMMARY OF THE INVENTION

A bearing includes a race and a plurality of rollers. The race has first and second radially inwardly directed collars on opposing ends of the race to form a channel. The first collar includes a first groove formed along an inner surface of the first collar, and the second collar includes a second groove formed along an inner surface of the second collars.

Each of the plurality of rollers has a central portion, a first nib extending from one end of the central portion and a second nib extending from an opposing end of the central portion. At least a portion of the first nib is positioned within the first groove and at least a portion of the second nib is positioned within the second groove to retain the plurality of rollers within the channel. The bearing is a full-complement needle bearing and is configured so that the rollers are maintained in place with the shaft removed.

In one aspect of the invention, the race may be formed from a ring, a first washer, and a second washer. The ring includes a first counterbore formed in a first side of the ring and a second counterbore formed in an opposing side of the ring. The first counterbore is shaped so as to receive at least a portion of the first washer and the second counterbore is shaped so as to receive at least a portion of the second washer. The first and second grooves are formed on inner surfaces of the first and second washers.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 illustrates a cross-section of one embodiment of a full complement needle bearing according to the present invention;

FIG. 2 illustrates a cross-section of another embodiment of a bearing according to the present invention;

FIG. 3 illustrates a cross-section plan view of a bearing race according to the present invention;

FIG. 4 is an exemplary tool in which the present bearing can be used in the tool handle and carrier;

FIG. 5 is an exploded view of another exemplary tool in which the bearing can be used in the tool handle and carrier;

FIG. 6 is an illustration of a stand-alone bearing; and

FIG. 7 is an illustration of the bearing incorporated into a tool handle.

### DETAILED DESCRIPTION OF THE INVENTION

While the present invention is susceptible of embodiment in various forms, there is shown in the figures and will hereinafter be described a presently preferred embodiment with the understanding that the present disclosure is to be considered an exemplification of the invention and is not intended to limit the invention to the specific embodiment illustrated.

It should be further understood that the title of this section of the specification, namely, “Detailed Description Of The Invention”, relates to a requirement of the United States Patent Office, and does not imply, nor should be inferred to limit the subject matter disclosed herein.

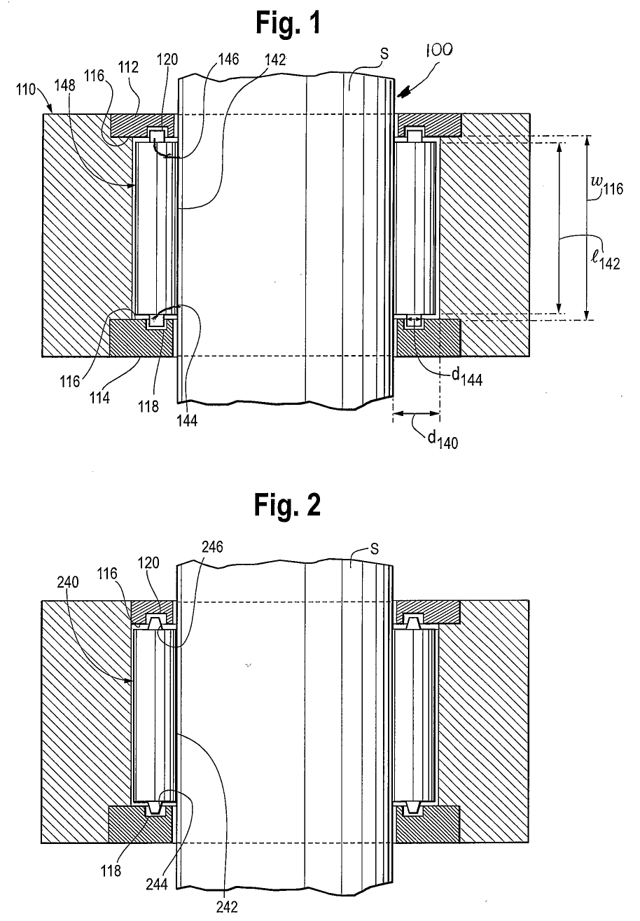

Referring to the figures, and in particular to FIG. 1, there is shown an embodiment of a full complement needle bearing 100 embodying the principles of the present invention. The bearing includes a race 110 and a set of rollers 140. The race 110 is a support or carriage to secure and maintain the rollers 140. The race 110 includes two radially inwardly directed collars 112 and 114. Each collar 112, 114 forms a radial channel 116 for the rollers 140. Each of the collars 112, 114 also includes a circular inner groove 118, 120 formed in the channel 116 wall. The inner grooves 118, 120 are used to retain the rollers 140 within the channel.

Each of the rollers 140 has a central portion 142 and two nibs 144, 146 extending from opposing ends of the central portion 142. The nibs 144, 146 define spindles or stubs that are concentric, e.g., coaxial, with a roller central portion 142. The central portion 142 is cylindrical in shape and preferably has a length l₁₄₂ that is approximately equal to, or slightly less than, a width w₁₁₆ of the channel 116 formed between the collars 112 and 114. The diameter d₁₄₀ of the rollers 140 is sufficiently large that the rollers 140 can contact a shaft S inserted into the center of the bearing 100 in order to allow for low-friction rotation of the shaft relative to the bearing 100. In one embodiment, each of the rollers 140 may be a needle roller having a length l₁₄₀ that is substantially greater than its diameter d₁₄₀.

The nibs 144 and 146 are shaped so that they are retained within the inner grooves 118 and 120. In the embodiment illustrated in FIG. 1, the nibs 144 and 146 are cylindrical in shape and have a diameter less than that of the central portion 142. The diameter (e.g., d₁₄₄) of the nibs 144, 146 is also preferably less than a width of the inner grooves 118, 120 so that the rollers 140 can move freely along the inner grooves 118, 120 when the nibs 144, 146 are positioned within the inner grooves.

In an alternate embodiment shown in FIG. 2, the nibs 244, 246 are tapered such that the ends of the nibs proximal to the central portion 242 have a diameter larger than at the distal ends. Of course, it is understood that other shapes may also be used so long as the rollers 240 are capable of being retained in the channel by the inner grooves 118 and 120. For example, the nibs may be conical, spherical, or any other suitable shape.

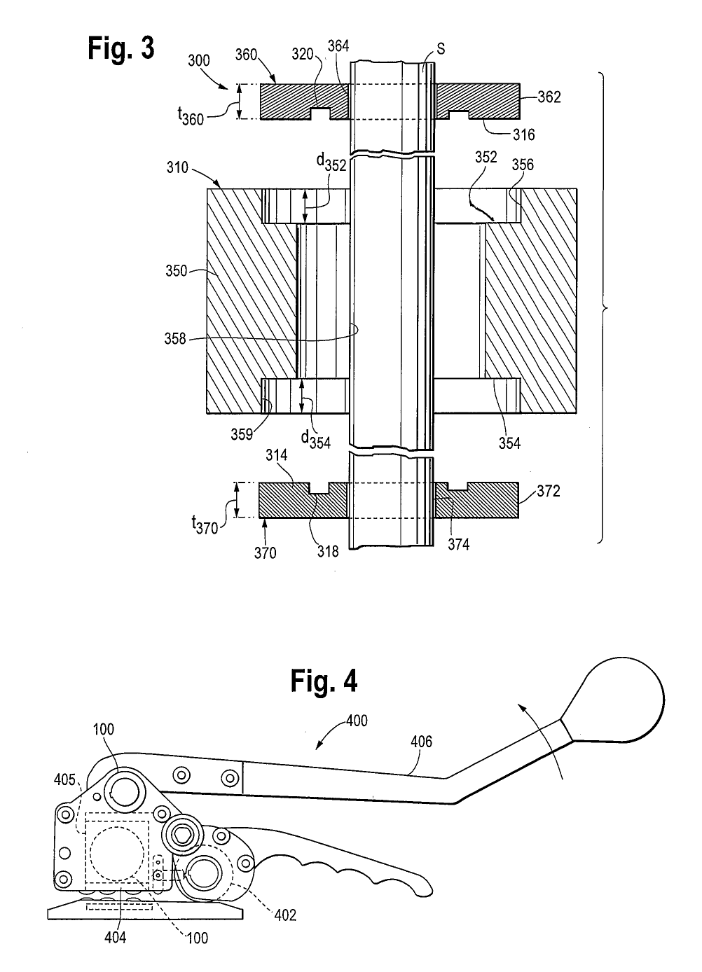

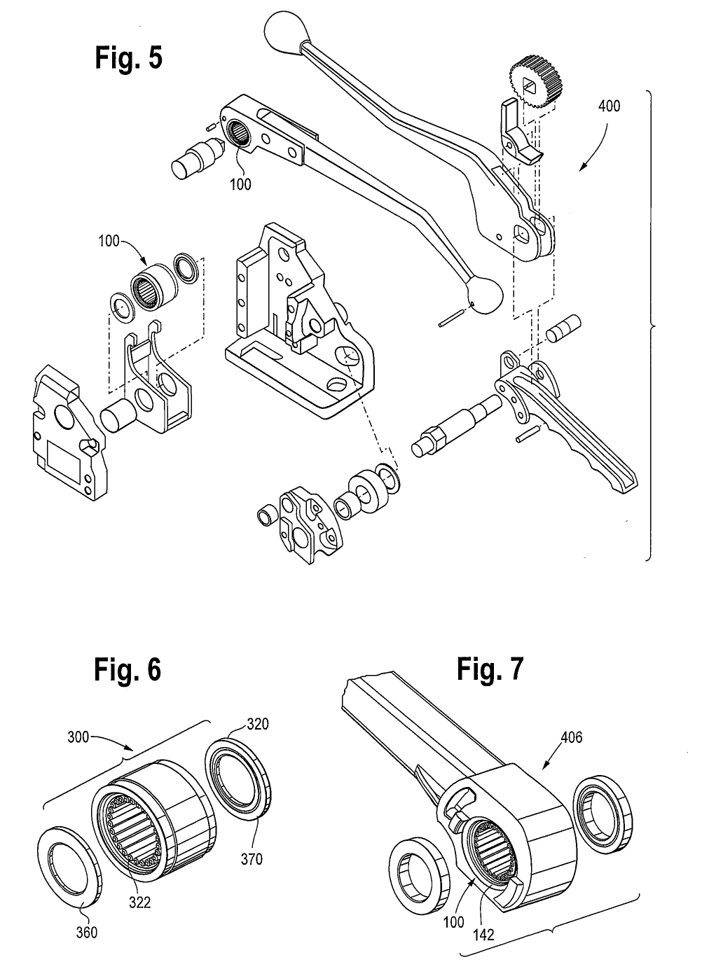

As best illustrated in FIG. 3, the race 310 may be formed from three components: an outer ring 350, a first washer 360, and a second washer 370. The inner surface 358 of ring 350 is generally cylindrical in shape and includes a first counterbore 352 formed in a first side of the race 310, and a second counterbore 354 formed in an opposing side of the race 310. Those skilled in the art will recognize that housings of other shapes (e.g., incorporation into tool handles) can be used, which housings are intended to rotate freely.

The first and second washers 360 and 370 are configured to be retained in the first and second counterbores 352 and 354, respectively, such as by press-fitting. In one embodiment, the first washer includes an exterior edge 362 that defines a diameter approximately equal to a diameter of a peripheral edge 356 of the first counterbore 352, and an interior edge 364 having a diameter greater than a diameter of the inner surface 358 of the ring. The first washer 360 also preferably has a thickness t₃₆₀ that is approximately equal to a depth d₃₅₂ of the first counterbore 352. Similarly, the second washer 370 has an exterior edge 372 having a diameter approximately equal to a diameter of a peripheral edge 359 of the second counterbore 354, and an interior edge 374 that defines a diameter greater than a diameter of the inner surface 358 of the ring 350. The washer 370 has a thickness t₃₇₀ that is approximately equal to a depth d₃₅₄ of the second counterbore 354. The inner grooves 318, 320 are formed in the portion of the each washer 360, 370 that extends inwardly past the inner surface 358 of the ring 350 when the washers 360, 370 are secured in the ring 350. Thus, when positioned within the first and second counterbores 352 and 354, the first and second washer form the collars 312 and 314. This configuration is proved so that a shaft S positioned in the bearing 300 rides on the rollers (not shown), and is free to rotate and is free from contact with the washer inner surfaces 358, 374.

To assemble the bearing 300, the first washer 360 is secured by pressing the first washer 360 into the first counterbore 352. One nib of each of the rollers is placed into the inner groove 320 of the first washer 360. The second washer 370 is then secured into the second counterbore 354 such that the opposing nib of each roller is within the inner groove 318 of the second washer 370. The rollers, by virtue of the inner grooves 318, 320 and the nibs, are therefore encapsulated and retained within the race channel 316. As a result, the rollers are prevented from falling out of the race 310 when a shaft S is removed from the center of the bearing 300.

As would be understood by one skilled in the art, the present invention may be used in various devices, tools, and motors. One example of a tool that may be used with the present invention is illustrated in FIG. 4. Such a tool can, for example, be a hand-held strapping tool, such as an SCM strapping tool manufactured by ITW Signode of Glenview, Ill. In a tool 400 of, for example, this type of tool, the bearing 100 can be used in the carrier 405 (positioned in the tool body 404) that moves up and down to punch the strap. The carrier 405 can be subjected to considerable forces and stresses, and it has been found that such a bearing 100 functions well in this environment. The bearing 100 can also be positioned in the tool 400 handle 406 to permit free rotation of the handle 406 during operation.

Other tools, including manual and powered tools can also benefit from the present full complement needle bearing. Those skilled in the art will appreciate that such tools are configured to tension a strap around a load, and can include functions to, for example, adhere the strap onto itself, and cut the feed end of the strap. The present bearing can also be used in a tensioning tool handle or the like.

Use of a full complement bearing allows the size of the strapping tool to be compact while providing a bearing that is capable of retaining the rollers when maintenance is performed on the component of the tool that is carried by the bearing (e.g., the shaft carried by the bearing).

It is also understood that various aspects and design features of the bearing may be modified without departing from the spirit of the invention. For example, one or both of the washers may be formed integrally with the ring. If both washers are formed integrally with the ring, the central portion and/or the nibs of the rollers may also be movable and biased (e.g., spring loaded) to allow for the nibs to be inserted into the inner grooves of the integral washers. The ring and/or the entire race may also be integrally formed with a tool, motor, or other device for which the bearing is being used. The dimensions of the ring, the first washer, the second washer, and the rollers may also vary depending on the application in which the bearing is being used.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover all such modifications as fall within the scope of the claims.

What is claimed is:

1. A full complement needle bearing comprising:
a race having first and second radially inwardly directed collars on opposing ends of the race to form a channel; the first collar having a first groove formed along an inner surface of the first collar, and the second collar having a second groove formed along an inner surface of the second collar; and
a plurality of rollers disposed within the channel, each of said plurality of rollers having a central portion, a first nib extending from one end of the central portion and a second nib extending from an opposing end of the central portion,
wherein at least a portion of the first nib is retained within the first groove and at least a portion of the second nib is retained within the second groove.

2. The bearing of claim 1 wherein each of the first and second nibs is substantially cylindrical in shape.

3. The bearing of claim 1 wherein each of the first and second nibs is tapered.

4. The bearing of claim 1 wherein the race is comprised of a ring, a first washer, and a second washer.

5. The bearing of claim 4 wherein the ring is substantially cylindrical in shape.

6. The bearing of claim 5 wherein the ring includes a first counterbore formed in a first side of the ring and a second counterbore formed in an opposing side of the ring, wherein the first counterbore is shaped so as to receive at least a portion of the first washer and the second counterbore is shaped so as to receive at least a portion of the second washer.

7. The bearing of claim 6 wherein the first groove is formed in an inner surface of the first washer and the second groove is formed in an inner surface of the second washer.

8. The bearing of claim 1 wherein the bearing is disposed in the handle of a tool.

9. The bearing of claim 1 wherein the bearing is disposed in the carrier of a tool.

10. The bearing of claim 1 wherein the bearing is a full-complement needle bearing.

11. A method for forming a full complement bearing comprising:
providing a ring having a first counterbore formed in a first side of the ring and a second counterbore formed in an opposing side of the ring;
providing a first washer having a groove formed along an inner surface of the first washer;
providing a second washer having a groove formed along an inner surface of the second washer;
providing a plurality of rollers, each of said plurality of rollers having a central portion, a first nib extending from one end of the central portion and a second nib extending from an opposing end of the central portion;
securing a first washer in the first counterbore to form a first inwardly radially directed collar;
inserting the first nib of each of the plurality of rollers into the groove of the first washer; and
securing a second washer in the second counterbore to form a second inwardly radially directed collar, wherein the second nib of each of the plurality of rollers is retained by the groove of the second washer.

12. A full complement bearing comprising:
a plurality of rollers, each of said plurality of rollers having a central portion, a first nib extending from one end of the central portion and a second nib extending from an opposing end of the central portion; and
a race having first and second radially inwardly directed collars on opposing ends of the race to form a channel, each of the first and second collars having retaining means for retaining the plurality of rollers within the channel.

13. The bearing of claim 12 wherein the retaining means comprises a groove formed along an inner surface of the first or second collar.

14. The bearing of claim 12 wherein the groove is shaped so to receive at least a portion of one of the first and second nibs from each of the plurality of rollers.

15. An apparatus having a full complement bearing comprising:
a race having first and second radially inwardly directed collars on opposing ends of the race to form a channel; the first collar having a first groove formed along an inner surface of the first collar, and the second collar having a second groove formed along an inner surface of the second collar; and
a plurality of rollers disposed within the channel, each of said plurality of rollers having a central portion, a first nib extending from one end of the central portion and a second nib extending from an opposing end of the central portion,
wherein at least a portion of the first nib is retained within the first groove and at least a portion of the second nib is retained within the second groove.

16. The apparatus of claim 15 wherein the apparatus is a strapping tool.

17. The apparatus of claim 15 wherein at least a portion of the race is formed integrally with the apparatus.
